(19) United States
(12) Patent Application Publication
(10) Pub. No.: US 2012/0203667 A1
(43) Pub. Date: Aug. 9, 2012

(54) System and method for charging a customer's cellular device account after retrieving the customer's cell phone balance via USSD

(76) Inventors: Michael Brody, New York, NY (US); Rodger Desai, Piscataway, NJ (US); Sung Kim, Fort Lee, NJ (US)

(21) Appl. No.: 13/373,069

(22) Filed: Nov. 3, 2011

Related U.S. Application Data
(60) Provisional application No. 61/456,291, filed on Nov. 3, 2010.

(51) Int. Cl. G06Q 30/06; G06Q 40/00

(52) U.S. Cl. 705/26.41; 705/35

(57) ABSTRACT

A system and method charges a customer's cellular account or another account for goods or services ordered from a merchant using USSD and/or other commands.

### FIELD OF THE INVENTION

The present invention is related to computer software and more specifically to computer software for processing payments charged to a mobile telephone account.

### BACKGROUND OF THE INVENTION

The related nonprovisional application describes a system and method for charging the customer of a merchant using their cellular device account. However, for some cellular device service providers, it can be cumbersome to implement such a system or operate the method, at least to perform a balance inquiry for a prepaid cellular device account.

What is needed is a system and method that can obtain the balance of a customer's cellular device account.

### SUMMARY OF INVENTION

A system and method receives from a merchant an amount to be charged to a customer's cellular device account the MSISDN and optionally the IMSI of the customer's cellular device. The cellular device may include a telephone or other type of device for which a monthly invoice is used to pay for service. If the IMSI is not received, it is obtained via an SRI_SM request to some or all of the cellular device service providers that operate in the country corresponding to the MSISDN received until one responds, thereby identifying both the IMSI of the customer and the customer's cellular device service provider. If desired, the merchant may restrict the countries corresponding to the cellular device service providers to which SRI SM requests may be sent.

If there is no such cellular device service provider, or none responds with an IMSI, the merchant is instructed not to provide the goods or services for which the charge is being made, and the merchant will comply. The merchant is not credited and the customer's cellular device account is not charged.

If such a service provider is identified, the service provider that responds to the SRI_SM request with a valid response is checked to determine whether that service provider is on a list of service providers who will return a VLR point code as the MSC in the response to the SRI_SM request. If the service provider is on the list, the MSC is used as the VLR point code.

Otherwise, either an ATI request or an SRI_LCS request, with the customer's IMSI, is provided to that service provider based on the known capabilities of the service provider, and the VLR point code for the customer is received in response.

The customer's balance is retrieved from the cellular device service provider via a USSD balance inquiry request using the payment processor's global title address but the customer's VLR point code (sent to the cellular device service provider's global title address). An indication may be received in the response as to whether the customer is a prepaid customer or a postpaid customer, whether their account is in good standing and, if prepaid, the current prepaid balance. If the customer has a postpaid account in good standing or the balance of the customer's prepaid account is sufficient to pay for the amount, the payment processor instructs the merchant to perform the goods or services action that caused the merchant to send the amount and MSISDN and the merchant will perform such goods or services action.

In one embodiment, instead of, or in addition to the balance request described above, a request is made to a financial institution that holds an account associated with the IMSI, MSISDN or both to determine whether a postpaid account is in good standing or a prepaid account has a balance sufficient for the amount. If the postpaid account is in good standing or the balance of the customer's prepaid account is sufficient to pay for the amount, the payment processor instructs the merchant to perform the goods or services action that caused the merchant to send the amount and MSISDN and the merchant will perform such goods or services action.

The customer's cellular device account or the associated account is charged an amount corresponding to the amount (e.g. the amount plus a service charge, or the amount), via a roaming charge, a USSD charge (again using the customer's VLR point code but the payment processor's global title address, as well as the IMSI), via Parlay X or a cellular service provider API, via a conventional Diameter charge or a conventional charge to the other account. The merchant is credited an amount corresponding to the amount received from the merchant, such as the amount or the amount less a service charge. The service charge may include any or all of a fee paid to the cellular service provider or financial institution of the other account, a fee for the payment processor, taxes such as a value added tax that the cellular service provider will collect for the merchant, geographical specific withholding tariffs, and the like.

If the balance is insufficient, the merchant is instructed not to perform the goods and services action and the merchant complies. The merchant will not receive a credit and the customer's cellular device account or other account will not be charged. The merchant may be informed of the reason why the merchant was so instructed, in order to allow the merchant to suggest suitable corrective measures for the customer to take, or to allow the merchant to inform the customer so that the customer may take such measures.

### BRIEF DESCRIPTION OF THE DRAWINGS

FIG. 1 is a block schematic diagram of a conventional computer system.

FIG. 2, consisting of FIGS. 2A and 2B, is a flowchart illustrating a method of checking the balance of, via USSD, a user's cell phone and/or other account and charging that account in response to an amount received from a merchant according to one embodiment of the present invention.

FIG. 3 is a block schematic diagram of a system for checking the balance of, via USSD, a user's cell phone and/or other account and charging that account in response to an amount received from a merchant according to one embodiment of the present invention.

### DETAILED DESCRIPTION OF A PREFERRED EMBODIMENT

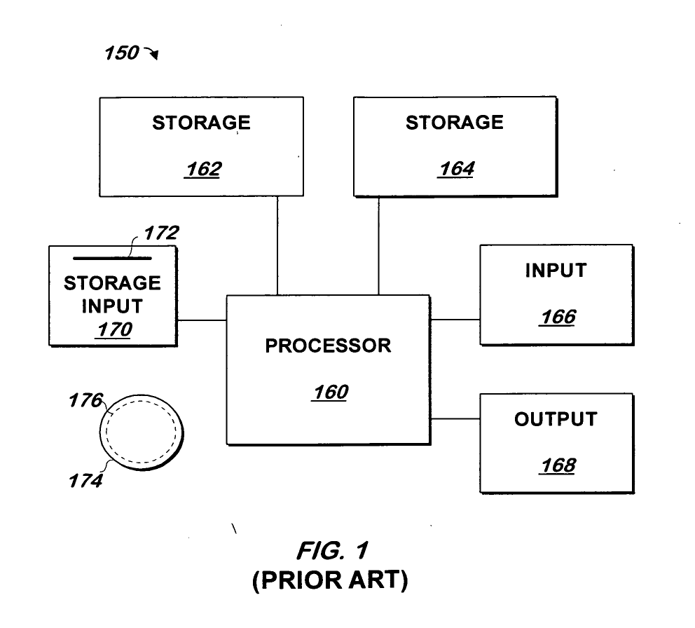

The present invention may be implemented as computer software on a conventional computer system. Referring now to FIG. 1, a conventional computer system 150 for practicing the present invention is shown. Processor 160 retrieves and executes software instructions stored in storage 162 such as memory, which may be Random Access Memory (RAM) and may control other components to perform the present invention. Storage 162 may be used to store program instructions or data or both. Storage 164, such as a computer disk drive or other nonvolatile storage, may provide storage of data or program instructions. In one embodiment, storage 164 provides longer term storage of instructions and data, with storage 162 providing storage for data or instructions that may only be required for a shorter time than that of storage 164. Input device 166 such as a computer keyboard or mouse or both allows user input to the system 150. Output 168, such as a display or printer, allows the system to provide information such as instructions, data or other information to the user of the system 150. Storage input device 170 such as a conventional floppy disk drive or CD-ROM drive accepts via input 172 computer program products 174 such as a conventional floppy disk or CD-ROM or other nonvolatile storage media that may be used to transport computer instructions or data to the system 150. Computer program product 174 has encoded thereon computer readable program code devices 176, such as magnetic charges in the case of a floppy disk or optical encodings in the case of a CD-ROM which are encoded as program instructions, data or both to configure the computer system 150 to operate as described below.

In one embodiment, each computer system 150 is a conventional SUN MICROSYSTEMS SPARC ENTERPRISE M9000 SERVER running the SOLARIS operating system commercially available from ORACLE CORPORATION of Redwood Shores, Calif., a PENTIUM-compatible personal computer system such as are available from DELL COMPUTER CORPORATION of Round Rock, Tex. running a version of the WINDOWS operating system (such as 95, 98, Me, XP, NT, 2000, VISTA or 7) commercially available from MICROSOFT Corporation of Redmond Washington or a Macintosh computer system running the MACOS or OPENSTEP operating system commercially available from APPLE INCORPORATED of Cupertino, Calif. and the FIREFOX browser commercially available from MOZILLA FOUNDATION of Mountain View, Calif. or INTERNET EXPLORER browser commercially available from MICROSOFT above, although other systems may be used. Each computer system 150 may be a DROID 2 mobile telephone commercially available from MOTOROLA CORPORATION of Schaumberg, Ill. running the ANDROID operating system commercially available from GOOGLE, INC. of Mountain View, Calif. Various computer systems may be employed, with the various computer systems communicating with one another via the Internet, a conventional cellular device network, an Ethernet network, or all of these.

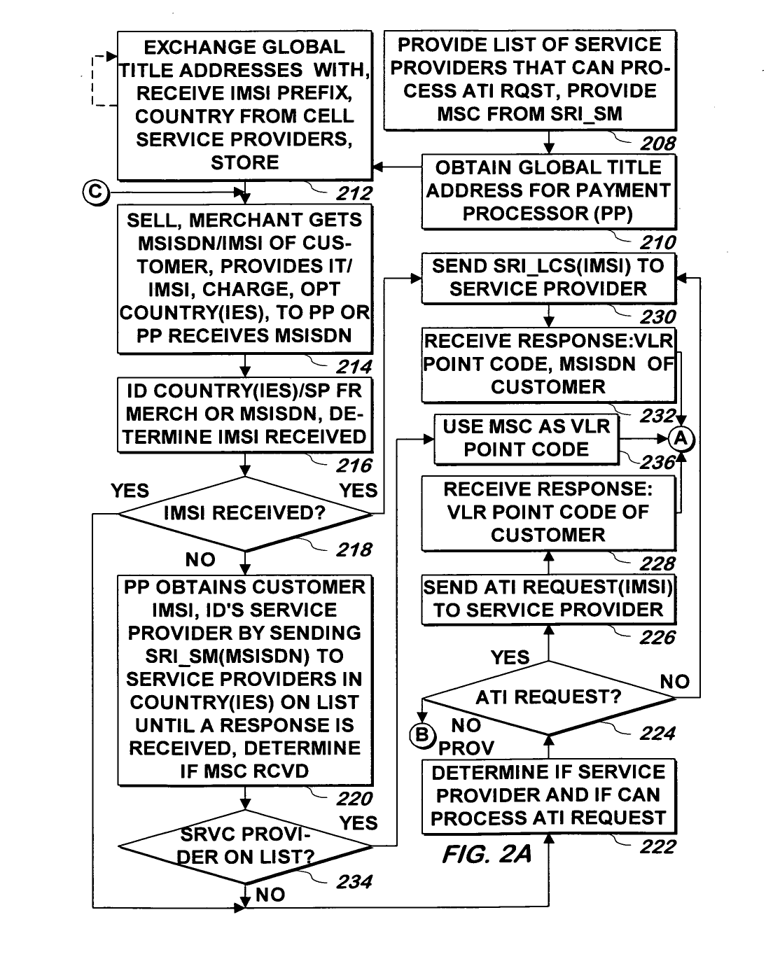

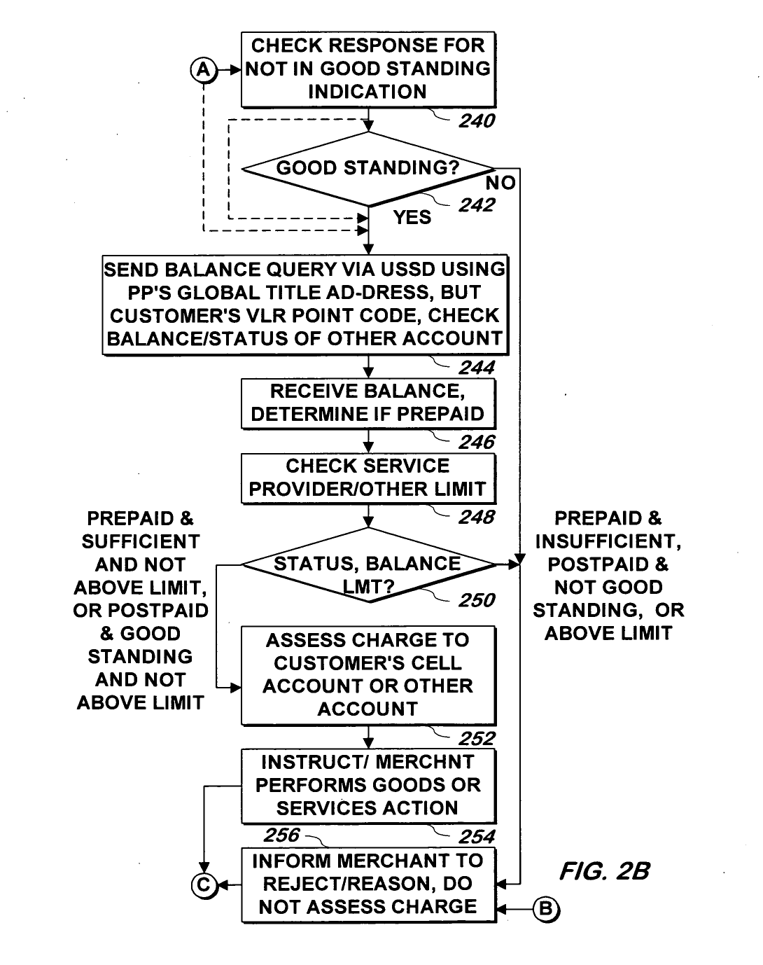

Referring now to FIG. 2A, a method of checking the balance of a customer's cell phone account and assessing to a customer's cell phone account, a charge corresponding to an amount received from a merchant is shown according to one embodiment of the present invention.

A list of service providers that can process an ATI request is provided and received 208. In one embodiment, the list of service providers that can process an ATI request is discovered by sending service providers ATI requests and identifying which service providers provide a valid response to such ATI requests. In other embodiments, service providers may be asked whether they can process ATI requests, and such service providers who affirmatively respond are added to the list.

In one embodiment, a list of service providers that will provide an MSC in response to an SRI SM request that is the VLR point code for the subscriber is also provided and received as part of step 208. The list may be obtained by comparing the MSC received against the VLR point code obtained using the other techniques described herein, or by asking the service providers that have authorized the payment processor to make charges to their subscriber accounts as described herein whether the MSC returned in response to an SRI_SM request is the VLR point code.

A global title address is obtained for a payment processor 210. As described in more detail below, a payment processor processes payment requests from merchants to be applied to cell phone accounts of customers of each such merchant. However, the payment processor may be the merchant itself in one embodiment. Although one merchant and one customer is described, the system and method may be used by any number of merchants, each with any number of customers.

A global title address is an address used in the SCCP protocol of Signaling System 7 networks for routing signaling messages on telecommunications networks, such as a USSD network used to control cellular device service. In one embodiment, a global title address is assigned by an assignment authority.

The payment processor and the cellular device service providers, who will allow the payment processor to charge cellular device accounts as described herein and in the related applications, exchange global title addresses with one another, and the name of the cellular device service provider, service provider code (that will be contained in the IMSI prefix of IMSI codes issued to their customers) and country covered by the cellular service provider is received from the cellular device service provider and such information for each cellular device service provider is stored associated together 212. Step 212 may operate as an independently running process, so that as additional cellular device service providers allow charges to be made to their subscriber's accounts, such information is exchanged as described above, received as described above, and stored as described above, with respect to the newly added cellular device service provider.

At any time, any one of a number of merchants may sell a product or service 214 to a customer of that merchant to be paid for via a charge made to the customer's cellular device account operated by or for a cellular device service provider that is also used to pay for cellular device services. In one embodiment, selling a product or service includes determining a charge for the product or service. The determination is performed at least in part at a computer system operated by, or on behalf of, the merchant, remotely from the computer system operated by the payment processor. The two computer systems communicate via a network, such as an Ethernet network, the Internet or both. The customer of the merchant is a party other than the payment processor, and any or all of the customer, merchant and the payment processor are each independent of one another, meaning one does not control the other.

In one embodiment, the goods or services are not related to cellular device services such as roaming, cellular device-related products and the like.

As part of step 214, in one embodiment, the merchant obtains the MSISDN of the customer, which may be the customer's telephone number, for example, by asking the customer to enter it when the customer checks out (or such information may be registered to the customer) and such MSISDN is received and stored by the merchant.

In one embodiment, as part of step 214, the merchant redirects the customer's browser to a web page operated by the payment processor, and the payment processor obtains the customer's MSISDN directly from the customer.

In one embodiment, such as where the merchant is using a system involving a locked down operating system on the customer's cellular device, the merchant obtains the customers IMSI corresponding to the SIM card in their mobile device instead of the MSISDN as part of step 214.

Also as part of step 214, the merchant provides the IMSI or the MSISDN, and an amount, to the payment processor, with an amount corresponding to the amount to be charged 214.

In the embodiment in which the merchant redirects the customer's browser to the payment processor, the merchant may provide the amount to the payment processor as part of the redirection. For example, the amount may be provided as part of the referrer information following the URL of the web page to which the customer is redirected, along with a hash of the amount, and a secret phrase, hashed with a hash key. The payment processor may rehash the amount received and the phrase using the secret hash key, and compare the hash result with the hash result from the referrer information in order to detect tampering with the amount. If the payment processor detects tampering, the method continues at step 256.

In one embodiment, the amount the merchant provides is the amount of the charge to be made to the cellular device account, and in another embodiment, the merchant provides the payment processor with a different amount from that to be charged to the user's cellular device account. The difference between the amount provided by the merchant and the amount charged may include a service fee, such as one paid to the payment processor by the customer, one paid by the customer to the cell phone service provider, or both. Service fees may include fees added by any of the actors described herein, taxes and the like.

In one embodiment, the merchant may also provide a list of one or more countries corresponding to the cellular device service providers that the merchant finds acceptable. As described below, if the cellular device service provider corresponding to the MSISDN received does business in a country that is not on the list, the charge will not be processed.

The cellular device service provider of the customer is identified 216 from the IMSI, or if the IMSI was not provided, a list of one or more countries, some or all of whose cellular device service providers may be queried to identify the customer's IMSI, is identified. If the IMSI was provided by the merchant, the cellular device service provider corresponding to the IMSI is identified from digits in the IMSI and a table of cellular device service providers and their respective codes corresponding to the IMSI, which may be received as part of step 208.

Otherwise, as part of step 216, a list of one or more countries that can be used to locate a cellular device service provider corresponding to the MSISDN is identified 216. If the merchant provided a list of countries as described above, the intersection of that list of countries and the countries that can correspond to the MSISDN is used. Otherwise, one or more countries corresponding to the MSISDN are identified using the MSISDN. A list of potential countries corresponding to various ranges of MSISDN values may be received as part of step 208, the list having been obtained via a query of different cellular device service providers or it may be obtained from other publicly available sources. A country corresponding to an MSISDN is a country to which some of the digits in the MSISDN correspond, such as a country code or area code.

For example, if the MSISDN corresponds to an MSISDN of the country of Spain, Spain is identified as the country corresponding to the MSISDN.

A determination is made as to whether the merchant provided the IMSI as part of step 216. If the merchant provided the IMSI 218, the method continues at step 222 in one embodiment, and in another embodiment, the method continues at step 230 (for example, where it is known that if the merchant provided the customer's IMSI, that the service provider will not process an ATI request).

If the merchant did not provide the IMSI, the payment provider obtains the customer IMSI, and identifies the customer's cell telephone service provider 220 by sending an SRI_SM request with the MSISDN provided by the merchant to one or more cellular device service providers known to provide service in the country or countries identified as described above until one such service provider provides a valid response to such a request. In one embodiment such providers used will be those with which payment processor has a contractual relationship to allow charging in the manner described herein. The service provider that provides a valid response will be identified as the customer's cellular device service provider, and the IMSI contained in the response is identified as the customer's IMSI.

It is noted that not every cellular device service provider, such as those identified as corresponding to a country, identified as being able to process an ATI request, etc, need be queried, as the payment processor may only have a relationship with a subset of the available cellular device service providers, and only such cellular device service providers need be used in the various queries and lists described herein.

In one embodiment, an MSC may be received with the response to the SRI_SM request. In such embodiment, step 220 may include checking the response for an MSC and checking the list of service providers that will provide an MSC in response to an SRI_SM request received as part of step 208. If an MSC was received in the response, 234, and the service provider is on the list, the MSC is used as the VLR point code 236 and the method continues at step 240. Otherwise 234, the method continues at step 222.

A determination is made as to whether any service provider exists (e.g. if no service providers having a relationship with the payment processor do business in a country on the list of countries provided by the merchant, no such cellular device service provider is considered to exist) and provided a valid response to the SRI_SM request, and if so the service provider of the customer is checked against the list received in step 208 to determine if that service provider can process an ATI request 222.

If no service provider exists or none provided a valid response to the SRI_SM request 224, the method continues at step 256 of FIG. 2B. If a service provider provided a valid response but that service provider cannot process an ATI request 224, the method continues at step 230. If a service provider provided a valid response and such service provider can process an ATI request 224, an ATI request containing the IMSI of the customer is provided to the service provider 226, and a response that may include the VLR point code of the customer is received, in response to the ATI request 228. The method continues at step 240 of FIG. 2B.

At step 230, an SRI LCS request with the customer's IMSI is provided to the service provider 230 that responded to the SRI_SM request (e.g. using the global title address of the cellular service provider). A response to the SRI_LCS request is received containing the VLR point code of the customer and the MSISDN 232, and the method continues at step 240 of FIG. 2B.

Referring now to FIG. 2B, in one embodiment, the cellular service provider may indicate that the customer's account with such provider is a postpaid account not in good standing in the response to the ATI request or the SRI_LCS request. In such embodiment, at step 240, the response of the ATI request or the SRI_LCS request is checked to determine whether it indicates that the customer is not in good standing. If not 242, the method continues at step 256, described below, and otherwise 242, the method continues at step 244.

In the embodiment in which the cellular service provider does not indicate whether the customer's account with such service provider is a postpaid account and the good standing of that account, instead of step 240, step 244 follows step 228 and/or step 232. In one embodiment, step 244 may follow step 240.

At step 244, the payment processor sends a balance query to the cell phone service provider identified as described above (e.g. using the global title address of the cellular service provider) via the USSD protocol using the payment processor's global title address, but the customer's VLR point code. The cellular device service provider will provide the customers balance to the payment processor, and such balance is received and a determination may be made as to whether the customer is a prepaid subscriber or a postpaid subscriber (i.e. one who receives credit and pays his bill at the end of the month, for example) if not otherwise indicated as described above 246. In one embodiment, the cellular service provider indicates whether the subscriber is postpaid in the response to the balance query. In such embodiment, the cellular service provider may indicate whether the account is or is not in good standing in such response, in the response to the ATI or SRI_LCS request (for example, by indicating an error to such request) or the technique used in the related applications may be used to determine if the account is in good standing. In one embodiment, the technique described in the related applications may be used to determine if the subscriber is postpaid and in good standing if the balance is returned as 0 (or a very low number) in response to the request.

In one embodiment, each cellular service provider may have a dollar amount limit for transactions involving postpaid accounts, prepaid accounts, and the limits may be the same for each or different limits may be used for prepaid accounts and postpaid accounts. The amount received from the merchant is compared against the cellular service provider identified from a portion of the IMSI that encodes it, and the type of account received. Each cellular service provider may specify a minimum balance that must remain in the customer's cellular carrier account after a transaction and the amount received from the merchant is compared against the limit to ensure that the balance in the account will not fall below it after the amount (plus any additional fees as described herein) is charged to the customer's account at the cellular service provider.

If the customer is a prepaid subscriber of the cellular service provider and the balance is sufficient for the amount to be charged to the customer's cell phone account 250, or the account is postpaid and the account is in good standing, (and optionally, the amount doesn't exceed a limit, such as an absolute limit corresponding to the cellular service provider, which may apply only to postpaid accounts or to prepaid and postpaid accounts, or a limit that is a function of the customer's balance retrieved as described above, the amount, and any minimum balance required by the cellular service provider) a roaming, USSD, Parlay X or other cellular service provider API, or diameter charge is assessed to the customer's cellular device account 252 based at least in part on the amount received from the merchant as described above, the merchant is instructed to perform any goods or services action and the merchant performs such goods or services action as described in the related applications, and the merchant receives a credit related to the charge 254.

In one embodiment, a customer may have an account at a financial institution that is associated with the IMSI, MSISDN, or both. The association may be made by the customer in any conventional manner of linking accounts. The account may be a prepaid account, such as a debit-type account, or it may be postpaid, such as a credit card account. In one embodiment, instead of or in addition to checking the account at the cellular service provider of the cellular device, the associated financial institution account may be checked to determine if the postpaid account is in good standing or the prepaid account has a balance sufficient for the amount as part of step 244. Step 250 may apply to either or both accounts, and the charge in step 252 may be made to the associated financial institution account instead of the cellular device account.

In the embodiment that a USSD charge is assessed, the charge is assessed using the IMSI obtained as described above, the customer's VLR point code and the payment processor's global title address as the source, the USSD message corresponding to the charge being sent to the cellular service provider's global title address as the destination. Step 254 may include providing a hash of the original amount, hashed with a different secret phrase and different secret key than may have been used when the merchant provided the amount, back to the merchant so that the merchant can detect tampering by hashing the amount and phrase using such secret key and comparing the hash result with the hash result it receives. If the merchant detects tampering, the merchant refuses to perform the goods and services action and informs the payment processor of the tampering, and the payment processor may reverse the charges using the same technique used to assess them. The method continues at step 214.

The amount charged to the customer's account at the cellular service provider may be the amount received from the merchant, plus a service charge, and the merchant may receive payment in the amount the merchant provided, or the amount charged to the customer's account at the cellular service provider may be the amount received from the merchant, and the merchant may receive the amount less a service charge, or some of the service charge may be charged to the customer and the remainder of the service charge applied against the amount received by the merchant. The service charge may include a revenue share amount paid to the cellular service provider, a fee paid to the payment processor, taxes such as a value added tax that the operator collects for the merchant, or other geographical specific withholding tariffs

If the customer is a prepaid subscriber of the cellular service provider and the balance is insufficient or is a postpaid customer and not in good standing (or optionally, the amount exceeds a limit, such as an absolute limit corresponding to the cellular service provider, which may apply only to postpaid accounts or to prepaid and postpaid accounts, or a limit that is a function of the customer's balance retrieved as described above, the amount, and any minimum balance required by the cellular service provider) 250, the merchant is instructed not to perform the goods and services action (or to use a different form of payment), the merchant complies, no credit is provided to the merchant, and no charge is assessed to the customers cellular device account 256. In one embodiment, step 256 includes informing the merchant why the merchant is being so instructed not to perform the goods and services action. In one embodiment, this may include informing the merchant that the customer's account at the cellular service provider is not in good standing or that the balance of the customer or the shortfall from the amount received from the merchant and the available amount of the customer's balance, and the merchant may inform the customer so that the customer can make suitable changes to his or her order, or so that the merchant may suggest other products or services the user can purchase that is within the amount of the customer's balance that may be charged. The method continues at step 214.

Any number of merchants, customers, and cellular device service providers may be used by the present invention in discrete amounts that differ by smallest unit of currency in the country corresponding to the merchant, for example in amounts to the penny for a U.S. merchant, though smaller amounts may also be used.

System.

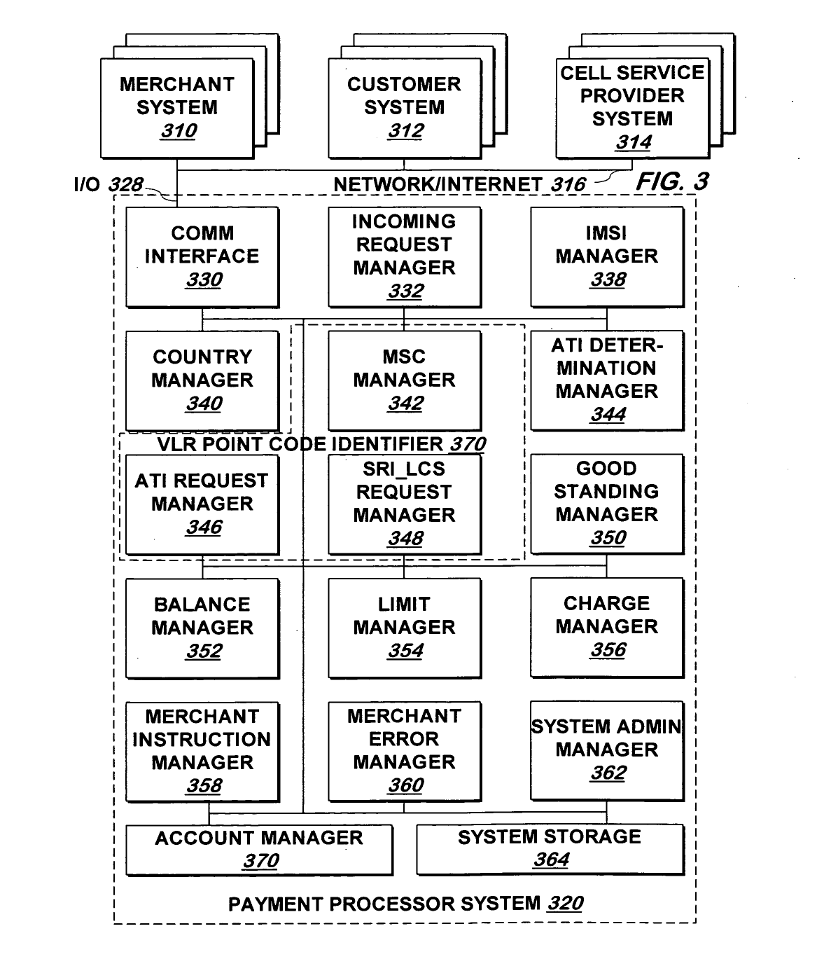

Referring now to FIG. 3, a system for charging a customer's account at a cellular service provider for a purchase at a merchant using USSD is shown according to one embodiment of the present invention. The system will contain at least one hardware component and is therefore, not software per se.

Overview of Systems.

Four types of systems may be used: one or more merchant systems 310, one or more customer systems 312, one or more cellular device service provider systems 314 and one or more payment processor systems 320, each coupled for communication as described herein via one or more conventional computer networks 316 such as the Internet. In one embodiment, each type of system 310, 312, 314 and 320 is operated by at least one entity that is independent of an entity operating one of the other types of systems. That is, a merchant is independent of the payment processor, who is independent from a cellular service provider, who is independent from a user. Independence means one of the entities does not control the other and is not under control of the other.

Customers use customer systems 312, each of which may be a conventional computer system such as a personal computer system, tablet computer system such as an IPAD commercially available from APPLE COMPUTER CORPORATION, netbook computer system, or a conventional cellular device to shop, add items to a shopping cart (or use an equivalent procedure) and check out via web pages provided by each merchant system 312 with which the users wish to purchase goods or services.

Merchant systems 312 and cellular service provider systems 314 may include conventional computer systems, including web server software. Three of each of systems 310, 312, 314 are shown, but there may be any number of such systems 310, 312, 314.

Certain Definitions.

As used herein, the term ‘or’ may mean “either, or both”. Customers are at least potential customers of a merchant and existing customers of a cellular service provider.

Provision of MSISDN or IMSI to Payment Processor System 320.

If the customer indicates via customer system 312 to the merchant system 310 during the aforementioned checkout process via a web page user input element provided by merchant system 310 that the customer wishes to pay the merchant with a conventional cellular device account, the merchant system 310 may request and receive the customer's MSISDN, which the customer provides via customer system 312.

In another embodiment, merchant system 310 requests and receives the customer's IMSI, directly from customer system 312, which may include a conventional cellular device, tablet, netbook, computer with a cellular modem, or other cellular-enabled device.

Merchant system 310 then supplies the IMSI or MSISDN, the amount of goods and/or services the customer ordered from the merchant (which may or may not include taxes, shipping and handling fees and other types of fees), an optional transaction identifier and an optional list of countries as described above to incoming request manager 332 of payment processor system 320. Payment processor system 320 includes elements 330-360 described below. Some or all of such elements 330-360 of payment processor system 320 may include manmade electronic circuitry. One such element is communication interface 330. Communication interface 330 includes a conventional communication interface such as a conventional Ethernet network interface running suitable communication protocols, such as Ethernet and TCP/IP. Communication interface 330 includes input/output 328 coupled to an Ethernet network, the Internet, or both.

In another embodiment, instead of requesting and receiving the customer's MSISDN and providing it to merchant system as described above, merchant system 310 redirects the user as described above to incoming request manager 332 of payment processor system 320 to allow incoming request manager 332 to request and receive the customer's MSISDN from the customer directly, which incoming request manager 332 does via customer system 312 via a user interface provided by incoming request manager 332. Merchant system 310 may supply the amount to incoming request manager 332 as part of the redirect as described above, and each 310, 332 may utilize additional security features described above in the manner described above. If an error is detected using the security features, incoming request manager 332 may so indicate to merchant error manager 360, which may inform the merchant of the error. In one embodiment, an encrypted transaction number and a hash of the transaction number are passed from merchant system to incoming request manager 332 and then to merchant error manager 360 in such event to allow the merchant to match the error with the request.

If such an error is detected, incoming request manager 332 additionally provides the IP address or other identifier of the merchant to merchant error manager 360 to respond to the merchant system 310 that sent the request.

In one embodiment, a merchant system 310 may supply (with the other information described above) an IMSI of the customer's cellular service provider to incoming request manager 332 instead of the customer's MSISDN. The merchant may receive such IMSI from the cellular service provider system as part of the interaction with the user system 312, which may be made through cellular service provider system 314. In such embodiment, merchant system 310 need not request and receive the customer's MSISDN.

Initial Processing of Merchant Provided Information.

If no security errors are detected, if an MSISDN is received, incoming request manager 332 builds into a transaction object an identifier of the merchant supplied by the merchant system or inferred via an IP address from the request, optionally the source IP address and port in the request, the amount received from the merchant system, a transaction identifier if supplied by the merchant system 310, the MSISDN, and any list of countries supplied by the merchant, and provides the transaction object to IMSI manager 338.

If an IMSI was received instead of an MSISDN, incoming request manager 332 builds the information described above (except for the MSISDN) into the transaction object as described above, adds the IMSI received into the transaction object, and provides the transaction object to IMSI manager 338.

System Administrator Supplied Lists.

In one embodiment, a system administrator supplies a list of identifiers of cellular service providers that have agreed to allow their subscriber accounts to be charged in the manner described herein and, for each such cellular service provider, the code or codes for the country or countries they serve that will be contained in a prefix portion of the MSISDN, along with one or more codes that are embedded in the IMSIs of customers they serve that identify such cellular service provider as corresponding to the IMSI, and their global title address, to system administration manager 362 via a system administrator computer system (not shown) coupled to network 316, and system administration manager 362 stores such information into system storage 364. System storage 364 may include conventional memory or disk storage and may include a conventional database. Country manager 340, IMSI manager 338, ATI determination manager 344, limit manager 354, and other elements may retrieve the information stored into system storage 364 for use as described below. Additional information may be included in this list of cellular service providers as described below.

The system administrator may also supply a list country names and their respective country codes that are in a prefix portion of the MSISDNs to country manager 340.

The system administrator may also supply a list of service providers that will return an MSC in the response to an SRI SM request as described above.

Determination of an IMSI that Corresponds to a Cellular Service Provider for Which Charges May Be Made.

When it receives the transaction object, IMSI manager 338 identifies whether the IMSI was included in the transaction object, for example, in a portion of the transaction object. If so, IMSI manager 338 looks up the global title address of the cellular service provider corresponding to the portion of the IMSI in the transaction object that identifies the cellular service provider using the list of cellular service providers it received from the system administrator as described above. If it locates in the list, the cellular service provider corresponding to the IMSI in the transaction object it receives, IMSI manager 338 adds the global title address to the transaction object, and provides the transaction object to ATI determination manager 332. If the IMSI received is not on the list, IMSI manager 338 provides the transaction object to merchant error manager 360 with an indication that the customer's cellular service provider has not arranged for their customers to charge goods and/or services of the merchant. If the IMSI was not provided, IMSI manager 338 provides the transaction object to country manager 340.

If No IMSI was Received, Attempt is Made to Identify IMSI of Customer and Corresponding Global Title Address of Cellular Service Provider.

When it receives the transaction object, country manager 340 identifies the zero or more cellular service providers designated as serving the country or countries corresponding to the country code of the MSISDN in the transaction object. If a list of countries was received from the merchant, country manager 340 limits its search for cellular service providers to those designated as operating in any country on the list. The lists received from the system administrator are used for such identifications. If no cellular service provider corresponding to such intersection, country manager 340 provides the transaction object to merchant error manager 360 with an indication that either the customer's cellular service provider had not agreed to allow charges to be made to its customers accounts to pay for goods and services of a merchant or the customer's cellular service provider was not in an acceptable country.

If it locates one or more such cellular service providers, country manager 340 sends SRI_SM messages as described above to each such cellular service provider as described above using, as the destination, the global title address of the payment processor from the list containing the global title addresses it received from the system administrator, and using as a source, the payment processor's global title address that country manager 340 receives from a system administrator. Country manager 340 receives the responses and stores into the transaction object the global title address of the cellular service provider that responds with the IMSI for the MSISDN it sends as part of the request, as well as any MSC received, and an identifier of the service provider from which the response was received. Country manager 340 also stores into the transaction object the IMSI contained in such response. If no cellular service provider provides such a response, country manager 340 provides the transaction object to merchant error manager 360, with an indication that either the customer's cellular service provider had not agreed to allow charges to be made to its customers accounts to pay for goods and services of a merchant or the customer's cellular service provider was not in an acceptable country. If such response is received, country manager 340 provides the transaction object to MSC manager 342.

MSC manager 342 either checks the list of service providers that provide an MSC in the response based on the service provider in the transaction object. If the service provider is on the list, MSC manager 342 copies the MSC into a VLR point code field in the transaction object and provides the transaction object to balance manager 352.

In one embodiment, MSC manager 342 may query the service provider to determine whether the account is in good standing, via an ATI request or any other conventional method, store the response into the transaction object and provide the transaction object to good standing manager 350 instead of balance manager 352.

If the service provider is not on the list, MSC manager 342 provides the transaction object to ATI determination manager 344.

Provide ATI Request or SRI LCS Request to Customer's Cellular Service Provider.

In one embodiment, the list of cellular service providers supplied by the system administrator additionally contains, for each such cellular service provider, whether the cellular service provider processes ATI requests or SRI_LCS requests. When it receives the transaction object, ATI determination manager 344 uses the cellular service provider's global title address in the transaction object, and the list of cellular service providers received from the system administrator, to determine whether the cellular service provider corresponding to the global title address processes ATI requests or SRI_LCS requests. If the cellular service provider corresponding to the global title address in the transaction object processes ATI requests, ATI determination manager 344 provides the transaction object to ATI request manager 346 and otherwise provides the transaction object to SRI_LCS request manager 348.

When it receives the transaction object, ATI request manager 346 sends an ATI request to the cellular service provider system 314 corresponding to the global title address in the transaction object, along with the IMSI from the transaction object, and receives a response containing the VLR point code of the mobile device corresponding to the IMSI, which ATI request manager 346 stores into the transaction object.

In one embodiment, an indication as to whether the account at the cellular service provider corresponding to the IMSI is a postpaid account in good standing may be received with the response to the ATI request, such response having been provided by the cellular service provider system 314. If so, ATI request manager 346 stores such indication into the transaction object and provides the transaction object to good standing manager 350, and otherwise (or if the good standing status is not specified, for example, because the account is prepaid), provides the transaction object to balance manager 352.

When it receives the transaction object, SRI_LCS request manager 348 sends an SRI_LCS request to the cellular service provider system 314 corresponding to the global title address in the transaction object, along with the IMSI from the transaction object, and receives a response containing the VLR point code of the mobile device corresponding to the IMSI, which SRI_LCS request manager 348 stores into the transaction object.

In one embodiment, an indication as to whether the account at the cellular service provider corresponding to the IMSI is a postpaid account in good standing may be received with the response to the SRI_LCS request, such response having been sent by such cellular service provider system 314. If so, SRI_LCS request manager 348 stores such indication into the transaction object and provides the transaction object to good standing manager 350, and otherwise (or if the good standing status is not specified, for example, because the account is prepaid), provides the transaction object to balance manager 352.

In one embodiment, a system administrator provides the global title address of the payment processor to ATI request manager 346 and SRI_LCS manager 348 to allow them to use such global title address as the source global title address of the messages they send. Communication interface 330 is also supplied with such global title address to enable it to receive replies to messages that contain that global title address as a source global title address. Communication interface 310 supplies responses to messages to the element that supplied such messages using conventional techniques.

Determine Good Standing Status of Customer.

When it receives the transaction object, good standing manager 350 investigates the indication as to whether the customer's cellular service provider postpaid account is in good standing. If so, good standing manager 350 provides the transaction object to balance manager 352 in one embodiment. If the account is not in good standing, good standing manager provides the transaction object to merchant error manager 360, with an indication that the account is not in good standing.

Identify Customer's Balance Via USSD.

When it receives the transaction object, balance manager 352 provides to the cellular service provider system 314 corresponding to the cellular service provider's global title address of the cellular service provider in the transaction object, a USSD balance request using such global title address, the customer's VLR point code in the transaction object, with a source global title address of the payment processor that corresponds to communication interface 330. The global title address of the payment processor is provided to balance manager 352 by the system administrator as described above. Communication interface 330 will route to balance manager 352 the response containing the balance, an indication as to whether the customer is a prepaid customer of the cellular service provider, optionally an indication of whether the customer is postpaid or prepaid and optionally, whether the account is in good standing (e.g. a credit limit for the customer account at the cellular service provider has not been exceeded). Balance manager 352 adds such items received to the transaction object.

If an indication that the account is not in good standing is received, balance manager 352 provides the transaction object to merchant error manager 360 and an indication that the customer's account is not in good standing. Otherwise, balance manager 352 provides the transaction object to limit manager 354.

Identify if Applicable Transaction Limits of Cellular Service Provider are Exceeded.

When limit manager 354 receives the transaction object, if the customer was not indicated as being postpaid as'described above, limit manager 354 compares the amount, plus any additional fees that will be charged to the cellular device account of the customer as described herein to the user's account balance, if any, stored in the. transaction object if the customer is not indicated in the transaction object as having a postpaid cellular account. If the customer is not indicated as having a postpaid cellular account and the balance exceeds the amount, plus any fees, by a threshold amount for the cellular service provider corresponding to the global title address stored in the transaction object, limit manager 354 provides the transaction object to charge manager 356. The list of cellular service providers provided by the system administrator may additionally contain, for each cellular service provider, such threshold amount and transaction limits for the cellular service provider, and such list is additionally provided to limit manager 354, which internally stores such list.

If the customer is not indicated as postpaid and the balance does not exceed the amount, plus any fees and the threshold for the cellular service provider corresponding to the global title address in the transaction object, limit manager 354 provides the transaction object to merchant error manager 360 with an indication that the balance is insufficient, and optionally, the amount of the shortfall.

If the customer is indicated as postpaid, limit manager 354 compares the amount of the transaction (optionally including any additional amounts that will be charged to the customer's cellular service provider account as described herein) to an applicable transaction limit for the service provider in the list of cellular service providers received from the system administrator and internally stored by limit manager 354. If the amount (or the amount plus any additional amounts) exceeds the limit for that cellular service provider, limit manager 354 provides the transaction object to merchant error manager, 360 with an indication that the cellular service provider transaction limit is being exceeded, and optionally provides the amount of the excess. If the applicable transaction limit is not being exceeded, limit manager 354 provides the transaction object to charge manager 356.

In one embodiment, the list of cellular service providers includes not only the transaction limit for postpaid accounts, but also a transaction limit for prepaid accounts, and each of those two amounts may be different for the same cellular service provider. In such embodiment, before providing the transaction object to charge manager 356 in the event that the amount, plus any additional amounts to be charged to the cellular service provider account of the customer are less than the prepaid balance as described above, limit manager 354 checks the amount (and optionally any other amounts to be charged to the customer's account of the cellular service provider) against the prepaid transaction limit corresponding to the cellular service provider. If the amount (and optionally any other amounts to be charged to the customers cellular service provider account) exceeds the limit, limit manager 354 provides the transaction object to merchant error manager, with an indication that the transaction limit has been exceeded, and the amount of the difference, and otherwise limit manager 354 provides the transaction object to charge manager 356.

Charge Customer's Cell Phone Account; Initiate Provision of Goods and Services Action.

When it receives the transaction object, charge manager 356 charges the customer's cellular service provider account via USSD or any of the other methods described above. To charge the customer's account, a USSD charge command is provided to the global title address in the transaction object, with the VLR point code of the customer in the transaction object and, as a source global title address, the global title address of the payment processor, received by charge manager 356 from a system administrator and stored internally by charge manager 356. Such command will be received by the cellular service provider system 314 and applied to the customer's account in a conventional manner by the cellular service provider. In one embodiment, the party operating payment processor system 320 either arranges for settlement to be made with each cellular service provider individually, or may arrange for settlement to be made via a central clearinghouse that offsets charges and credits among various cellular service providers by the payment processor registering at the clearinghouse as a cellular service provider (even though it may provide no cellular services, or less than 10% of the charges it processes are for cellular services). Charge manager 356 stores in a database it internally maintains the amount, plus any of the additional amounts and/or credits to the cellular service provider described above, and to the merchant, by storing in an internally maintained database the amount due from the cellular service provider and the amount due the merchant, optionally along with any transaction identifier, and the date and time of the charge. Charge manager 356 provides the transaction object to merchant instruction manager 358.

In one embodiment, balance manager 352 will also or instead perform the above actions (and add the corresponding information to the transaction object), and charge manager 356 will instead perform the above actions, for an account at a financial institution that is associated with the IMSI, MSISDN or both in system storage 364. Such information may be requested by balance manager 352 and charges made by charge manager 356 using any conventional technique. The account may include an account number, an indication as to whether the account is prepaid or postpaid and the routing number or other identifier of the financial institution of the account. Such information may be provided either by a customer system or a system administrator system (not shown) communicating with account manager 370, which stores such information into system storage 364 associated with the MSISDN, IMSI or both and such linkage is verified by account manager using conventional techniques (e.g. text message to the phone requesting, receiving and verifying entry of a code, and depositing and removing funds from the account and requesting, receiving and verifying entry of the amounts). Limit manager 354 may use information for the cellular device account as described above, similar information for the other account, or both to perform the actions described above, with the determination as to whether the account is prepaid or postpaid either being provided by the financial institution or system storage 364. In one embodiment, the account at the financial institution may be used if the transaction limits of the cellular service provider are exceeded or if the balance is exceeded or not in good standing at the cellular service provider but no such issues are indicated for the financial institution account.

When it receives the transaction object, merchant instruction manager 358 retrieves from the transaction object the merchant identifier or IP address, the amount, and any transaction identifier provided by the merchant and provides the amount, transaction identifier and optionally a hash of the amount as described above to the merchant system 310 from which the charge request was received. The merchant system 310 may validate the amount and hash as described above and if validated, provides the goods or services ordered by the customer, for example by shipping them or otherwise providing them, for example, digitally from merchant system 310 to user system 312, where they may be physically stored in flash memory or on a hard disk of user system 312 or a device such as a music player attached thereto. Performing a goods and services action may include enabling content to be provided, for example, by streaming it from a server to a client computer system such as customer system 312 or a different computer system. Performing a goods and services action may include providing goods and/or services to a party unknown to the customer, for example, if the customer is making a donation, and may include providing a message to the customer thanking the customer for his or her donation, such message being displayed on customer system 312. In one embodiment, merchant system 310 provides to customer system 312 from which the order for the goods and/or services was received, an indication that the transaction was successful and customer system 312 displays to the user an indication of such success.

Settlement.

Each customer pays its respective cellular service provider (either before or after the transaction is processed as described herein. In one embodiment, each cellular service provider pays the payment processor for the transactions processed as described herein and the payment processor pays the merchants for the transactions processed as described herein. As noted, the merchant may receive less than the amount the merchant provided for each transaction, or the cellular service provider may remit more or less than the amount it received from the payment processor system 320 as described herein.

In one embodiment, for one or more of the merchants operating merchant systems 310, for some or all of the transactions initiated by such merchants, instead of settlement operating as described above, the merchant system 310 periodically invoices the each cellular service provider system 314 for the amount due the merchant from the cellular service provider receives payments for such invoices. Such embodiment may be used where the merchant operating such merchant system runs a conventional cellular “app store”, selling applications or other services to users of cellular devices. In such embodiment, the merchant may have an agreement with each cellular service provider as to the amount it will invoice based on the amount that was provided to the cellular service provider or amount merchant system 310 provided as described above, and the invoice contains the sum of the amounts the merchant will invoice during the period to which the invoice applies. The transaction identifiers or other means of identifying the transaction, such as the amount, date and time, may be provided by the merchant system 310 as part of the invoice. The merchant receives payment for such invoices.

In such embodiment, the merchant may provide payment for payment processing services on a per transaction basis, percentage of transaction basis, or both, to the payment processor, the party on whose behalf the payment processor system 320 is operated. The cellular service provider may provide payment to the payment processor either in addition to the payment from the merchant or instead of it, using a similar basis as that described for the merchant. Invoices consistent with the descriptions herein may be generated by charge manager 356 containing the information on the reconciliation assistance report described below, and such invoices may be provided to the merchant corresponding to the charges initiated by that merchant, to the cellular service provider to whom charges were sent, or both.

In order to allow the merchant system 310 to provide the proper invoices and payments, as noted above, in one embodiment, a merchant system 310 sends a transaction identifier with the other information it sends to payment processor system 320 as described above. In one embodiment, merchant instruction manager 358 provides to the merchant system 310 described above an the identifier of the cellular service provider contained in the IMSI (or another identifier of the cellular service provider using a list of such other identifiers and identifiers of cellular service providers it receives from a system administrator and internally stores) from the transaction object it receives in addition to the other information provided to the merchant system 310 as described above.

Payment submitted to the payment processor references the transaction identifier or the amount, date and time, of each transaction for which the payment is being sent to allow the payment processor to verify the payment.

In one embodiment, the transaction identifier for each transaction is provided to the cellular service provider system 314 by charge manager 356 as part of the USSD charge command (using an available field) or separately as part of a reconciliation assistance report it provides to each cellular service provider operating a cellular service provider system 314. If provided separately, the date, time and amount may also or instead be included on the reconciliation assistance report. The cellular service provider may reconcile the invoice it receives from the merchant using the reconciliation assistance report before it pays the merchant.

Handling of Errors.

When it receives the transaction object, and any indications or other information as described herein, merchant error manager 360 retrieves the merchant system IP address or other merchant identifier in the transaction object, and provides to the corresponding merchant system 310 any transaction identifier, amount received from the merchant and an indication to the merchant not to perform the goods or services action. As a result, the merchant will not ship goods or provide services corresponding to the amount and any transaction identifier.

In one embodiment, merchant error manager 360 additionally provides the merchant system 310 the indication received with the transaction object and any other information received, such as a shortfall, as described herein. The receiving merchant system 310 may provide to customer system 312 corresponding to the customer placing the order corresponding to the transaction, an indication of the problem preventing the charge corresponding to the one it receives based on the information it receives from merchant error manager 360, and may provide suggestions to the user regarding how to remedy the problem. Solutions may include increasing the balance in the cellular device account, removing some of the products or services purchased from the customer's shopping cart and optionally replacing them with less expensive replacements for the products and/or services removed.

In one embodiment, any one or more of MSC manager 342, ATI request manager 346 and SRI_LCS request manager 348 are referred to as a VLR point code identifier 370. Not all of 342, 346 and 348 need be used.

The various requests are conventional mobile communications requests, such as those described in the mobile application part interface (MAPI) specification available from the Open SS7 Project at openss7.org.

What is claimed is:

1. A method of initiating a charge to a cellular device account, comprising:
receiving an identifier of a cellular device and an amount;
obtaining a VLR point code responsive to the identifier of the cellular device;
initiating the charge to a payment account of the cellular device using the VLR point code obtained; and
directing a merchant to ship goods or services related to the charge.

2. The method of claim 1, wherein the VLR point code is obtained using an MSC of an SRI_SM response.

3. The method of claim 2, wherein the VLR point code is obtained additionally responsive to a list of a plurality of service providers that provide an MSC in a response to an SRI_SM response.

4. The method of claim 1 wherein the VLR point code is obtained additionally responsive to an ATI request.

5. The method of claim 4:
additionally comprising identifying a party that can provide the VLR point code; and
wherein the VLR point code is obtained responsive to the ATI request additionally responsive to a determination that the party to provide the VLR point code can process an ATI request.

6. The method of claim 1 wherein the VLR point code is obtained additionally responsive to an SRI_LCS request.

7. A system for initiating a charge to a cellular device account, comprising:
a request manager having an input coupled to a computer network for receiving an identifier of a cellular device and an amount, the request manager for providing at an output the identifier of the cellular device and the amount;
a VLR point code identifier having an input coupled to the request manager output for receiving the identifier of the cellular device, the VLR point code identifier for obtaining via an input/output a VLR point code responsive to the identifier of the cellular device received at the input and for providing the VLR point code at an output; and
a charge manager having an input coupled to the VLR point code identifier output for receiving the VLR point code, the charge manager for initiating at an output the charge to a payment account for the cellular device using the VLR point code received at the charge manager input.

8. A computer program product comprising a computer useable medium having computer readable program code embodied therein for initiating a charge to a cellular device account, the computer program product comprising computer readable program code devices configured to cause a computer system to:
receive an identifier of a cellular device and an amount;
obtain a VLR point code responsive to the identifier of the cellular device;
initiate the charge to a payment account of the cellular device using the VLR point code obtained; and
direct a merchant to ship goods or services related to the charge.

9. The computer program product of claim 8, wherein the VLR point code is obtained using an MSC of an SRI_SM response.

10. The computer program product of claim 9, wherein the VLR point code is obtained additionally responsive to a list of a plurality of service providers that provide an MSC in a response to an SRI_SM response.

11. The computer program product of claim 8 wherein the VLR point code is obtained additionally responsive to an ATI request.

12. The computer program product of claim 11:
additionally comprising computer readable program code devices configured to cause the computer system to identify a party that can provide the VLR point code; and
the VLR point code is obtained responsive to the ATI request additionally responsive to a determination that the party to provide the VLR point code can process an ATI request.

13. The computer program product of claim 1 wherein the VLR point code is obtained additionally responsive to an SRI_LCS request.
